(19) United States
(12) Patent Application Publication
(10) Pub. No.: US 2016/0004316 A1
(43) Pub. Date: Jan. 7, 2016

(54) GESTURE BASED COMPUTER INTERFACE SYSTEM AND METHOD

(71) Applicant: TACTILE WORLD LTD., Raanana (IL)

(72) Inventors: Igor KARASIN, Raanana (IL); Vsevolod MINKOVICH, Raanana (IL); Gavriel KARASIN, Raanana (IL)

(73) Assignee: TACTILE WORLD LTD., Raanana (IL)

(21) Appl. No.: 14/513,811

(22) Filed: Oct. 14, 2014

Related U.S. Application Data
(63) Continuation of application No. 13/578,706, filed on Aug. 13, 2012, now abandoned.

(30) Foreign Application Priority Data
Feb. 11, 2010 (IL) 203920

(51) Int. Cl. G06F 3/01; G06F 3/038; G09B 21/00; G06F 3/0354

(52) U.S. Cl. CPC G06F 3/017; G06F 3/016; G06F 3/03543; G06F 3/038; G09B 21/003

(57) ABSTRACT

Gesture generated commands are input into a computer by use of a system including a hand movable input device having a hand-holdable housing for the effecting of a gesture by a user; and sensor apparatus for sensing predetermined motions of the housing with respect to a biaxial system and for transmitting signals corresponding to sensed motions of the housing, to a computer; signal interpretation software for interpreting signals from the sensor apparatus as being gesture-generated and for emitting a predetermined command to the computer corresponding to the gesture; non-visual display apparatus including one or more tactile output device; and a computer program for operating the non-visual display apparatus so as to provide to a user information relating to a combination of hand motions corresponding to a command.

### CROSS REFERENCE TO RELATED APPLICATIONS

This is a Continuation of co-pending U.S. patent application Ser. No. 13/578,706, filed Aug. 13, 2012, which is the National Stage of International Patent Application No. PCT/IL2011/000147, filed Feb. 10, 2011, which claimed priority to Israel Patent Application No. 203920, filed Feb. 11, 2010.

### FIELD OF THE INVENTION

The present invention relates to data input and computer control and navigation.

### BACKGROUND OF THE INVENTION

In the use of computer systems, there exist various means for the input of commands. Typically, such means include key combinations, mouse motions and mouse clicks, the input of most commands being possible by either or all means. Prior to the use of a mouse click to input a command, the mouse is used to navigate from one portion of a display to another so as to align the cursor with an icon used to access a program, a menu item such as “File” or “Edit” in the Microsoft Word® word processor, a hyperlink or other objects.

A significant disadvantage of these systems is that as they require eye hand coordination, they are not suitable, per se, for use by the visually impaired, or by those whose manual and mental dexterity is limited.

“Gestures” per se, are known in the world of computer interfaces, including, for example, in the context of computer games. A discussion of this subject, entitled “Pointing Device Gesture” may be found at http://en.wikipedia.org/wiki/Pointing_device_gesture.

A discussion of the Nintendo® Wii® computer game, may be found at http://en.wikipedia.org/wiki/Wii.

An article which discusses computer interfaces is Buxton, W. A. (1995). “Chunking and phrasing and the design of human-computer dialogues” in Human-Computer interaction: Toward the Year 2000, R. M. Baecker, J. Grudin, W. A. Buxton, and S. Greenberg, Eds. Morgan Kaufmann Publishers, San Francisco, Calif., 494-499; which may be found at http://www.billbuxton.com/chunking.html.

One disadvantage of known gesture based interfaces, is that they require eye hand coordination, they are not suitable, per se, for use by the visually impaired, or by those whose manual and mental dexterity is limited.

### DEFINITIONS

In the present description, the following terms have meanings as defined herewith:

Computer: All electronic devices that can store, retrieve, and process data. This includes, merely by way of non-limiting example, all desktop and mobile devices.

Gesture: A predetermined hand motion or sequence of hand motions for the entering of a computer command.

Component motion: A single predetermined hand motion combining with at least one other predetermined hand motion to form a gesture.

### SUMMARY OF THE INVENTION

There is provided a ‘gesture’ based interface which relies on non-visual prompts, particularly tactile, and which, while being particularly suited for the visually impaired, may also be found to be useful, inter alia, by children and by the elderly.

The system, in its most basic form, is based on the use of a handheld device which may be shaped like a computer mouse, and its use to perform gestures as defined above, interpreted as commands for operating a computer.

While the system may be used both by sighted and able-bodied persons, as it is intended to be used by the visually impaired on the one hand, and by those whose manual and/or mental dexterity may be limited, the gestures will preferably have the following characteristics:

1. easily made by the user,
2. clearly distinct one from the other, and
3. easy to remember.

In accordance with a preferred embodiment of the invention, there is provided a system for the inputting of gesture generated commands into a computer by a user, which includes:

(a) a hand movable input device which includes:

(i) a hand-holdable housing for the effecting of a gesture by a user; and

(ii) sensor apparatus for sensing predetermined motions of the housing with respect to a biaxial system and for transmitting signals corresponding to sensed motions of the housing, to a computer;

(b) signal interpretation software for interpreting signals from the sensor apparatus as being gesture-generated and for emitting a predetermined command to the computer corresponding to the gesture;
(c) non-visual display apparatus including one or more tactile output device; and
(d) a computer program for operating the non-visual display apparatus so as to provide to a user information relating to a combination of hand motions corresponding to a command

Additionally in accordance with a preferred embodiment of the invention, the one or more tactile output device is mounted onto the hand-holdable housing.

Further in accordance with a preferred embodiment of the invention, the computer program operates the non-visual display apparatus so as to provide non-visual output containing information which includes the following:

(a) instructions for the movement of the input device in a sequence of hand motions required to input a selected command; and
(b) an indication as to the successful completion of the sequence of hand motions required to input a selected command

Further in accordance with a preferred embodiment of the invention, the computer program operates the non-visual display apparatus so as to also to provide feedback to the user in real time and in non-visual form as to the successful performance of a sequence of hand motions required to input a selected command

Additionally in accordance with a preferred embodiment of the invention, the computer program operates the one or more tactile output device so as to provide tactile output containing information which includes one or more of the following:

(a) instructions for the movement of the input device in a combination of hand motions required to input a selected command;
(b) an indication as to the successful completion of a combination of hand motions required to input a selected command; and
(c) feedback as to the successful performance of a combination of hand motions required to input a selected command

Further in accordance with a preferred embodiment of the invention, the apparatus for sensing is operative to sense predetermined sequences of motions of the housing wherein each the sequence includes at least two motions performed consecutively.

Additionally in accordance with a preferred embodiment of the invention, the axes are orthogonal linear axes defined by the sensor apparatus and each the motion is performed with respect to a single axis of the pair of axes.

Further in accordance with a preferred embodiment of the invention, the signal interpretation software is operative to approximate each motion as being along a straight line.

Additionally in accordance with a preferred embodiment of the invention, the hand movable input device is a tactile computer mouse.

There is also provided, in accordance with a further embodiment of the invention, a method of gesture operation of a computer so as to effect a selected task, including the following steps:
(a) manually moving a hand held computer interface device in order to perform a gesture required to effect a task;
(b) detecting the motion of the interface device with respect to a biaxial system;
(c) comparing the motions performed with those required to effect the selected task; and
(d) providing non-visual feedback to the user as to whether or not the gesture was performed successfully.

In the present method, there are preferably also provided one or more steps of displaying to a user in non-visual form one or more instructions for one or more motions required for the performance of a gesture in order to effect the selected task.

Further in the present method, during the performance of step (a) of manually moving, there is preferably provided the additional step of providing non-visual feedback to the user as to whether or not component motions of the gesture were performed successfully.

Additionally in the present method, step (d) displaying preferably includes providing tactile feedback to the user.

Further in the present method, in the one or more steps of displaying, the instructions are preferably provided in tactile form.

Additionally in a preferred embodiment of the present method, in the step (b) detecting, the axes are orthogonal linear axes; each motion is performed with respect to a selected one of the axes; and the step (b) includes the step of approximating each motion as being along a straight line.

In accordance with yet a further embodiment of the invention, the invention is preferably implemented in a tactile computer game.

### BRIEF DESCRIPTION OF THE DRAWINGS

The present invention will be more fully understood and appreciated from the following drawings in which:

FIG. 1 is a diagram of a PRIOR ART computer system;

FIG. 2 is a diagram of a computer system incorporating the interface system of the present invention;

FIG. 3 is a functional block diagram of a single level interface system constructed and operative in accordance with a preferred embodiment of the present invention;

FIG. 4 is a functional block diagram of a multiple level interface system constructed and operative in accordance with an alternative embodiment of the present invention;

FIG. 5a is a diagram of a two axis arrangement for the determination of the direction of a motion in an “UP”, “DOWN”, “LEFT”, “RIGHT” system;

FIG. 5b shows a sequence of non-linear motions;

FIG. 5c shows the sequence of FIG. 5b after transformation into a plurality of linear motions;

FIG. 6 is a block diagram of a multiple level interface system constructed and operative in accordance with yet a further embodiment of the present invention;

FIGS. 7a and 7b are pictorial views of a tactile mouse, such as shown and described in any of U.S. Pat. Nos. 6,762,749 and 6,278,441, both entitled “Tactile interface system for electronic data display system,” and U.S. Pat. No. 5,912,660, entitled “Mouse-like input/output device with display screen and method for its use”, the contents of which are incorporated herein by reference;

FIGS. 7c and 7d are further schematic representations of a tactile mouse according to an exemplary embodiment of the invention;

FIG. 7e is a block diagram showing the main elements of a driving mechanism for the tactile display of FIG. 7a, in accordance with a preferred embodiment of the invention;

FIG. 8 is a general flow diagram illustrating the basic structure of a game or exercise for training a user in the use of a gesture input device, in accordance with an embodiment of the present invention;

FIG. 9 is a diagrammatic illustration of component motions and gestures which may be employed in the game or exercise of FIG. 8;

FIG. 10-13 are examples of the operation of tactile pads such as forming part of the tactile mouse illustrated in FIG. 7, in a manner adapted to indicate to a visually impaired user desired directions of motions;

FIG. 14 is a diagram illustrating a hybrid training exercise for a user of a tactile mouse incorporating a gesture input device;

FIG. 15 is a schematic block diagram of a computer system having as separate elements a display and a gesture input device, constructed and operative in accordance with an embodiment of the present invention; and

FIG. 16 is a schematic block diagram of a computer system having a tactile mouse in which are incorporated displays, in the form of tactile output devices, and a gesture input device.

### DETAILED DESCRIPTION

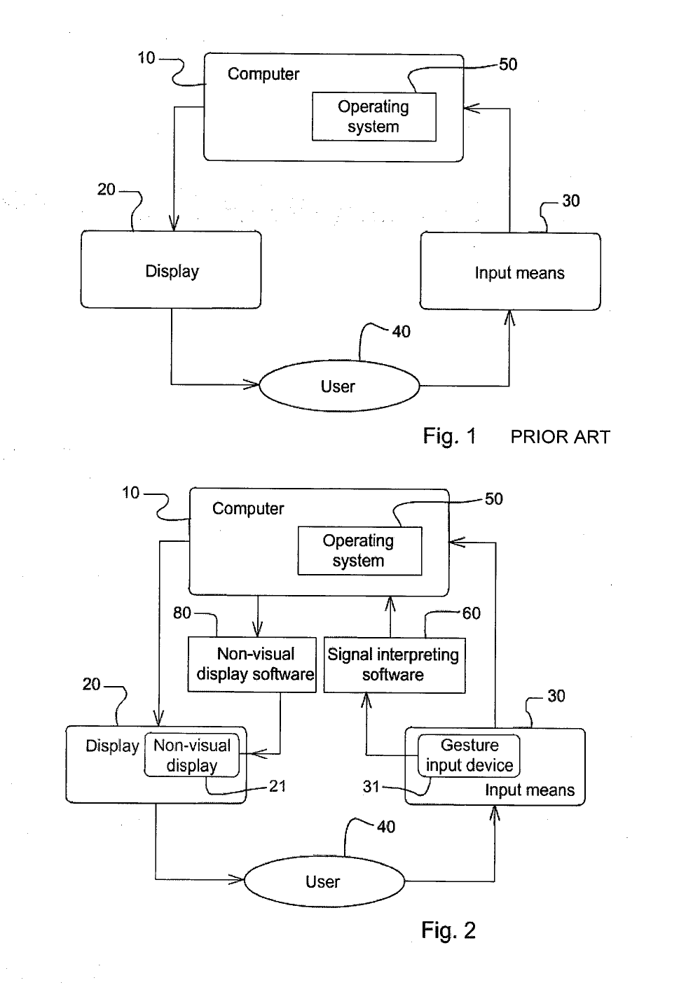

Referring now to FIG. 1, there is shown a PRIOR ART personal computer system which includes a computer 10, a display or other output means 20, an input means 30, such as a keyboard, computer mouse or the like, all of which combine into a single system operating in conjunction with software 50. Software 50 could be any known operating system and additional applications and utilities. A user of the computer system is illustrated schematically at 40.

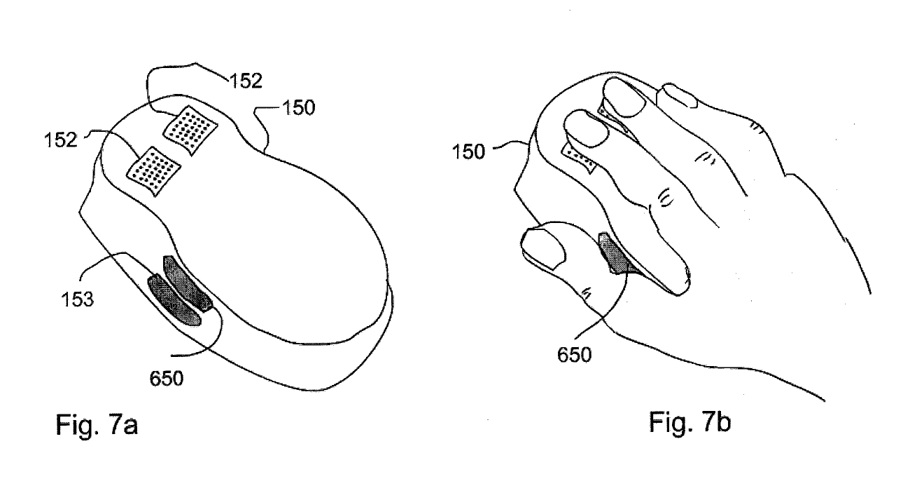

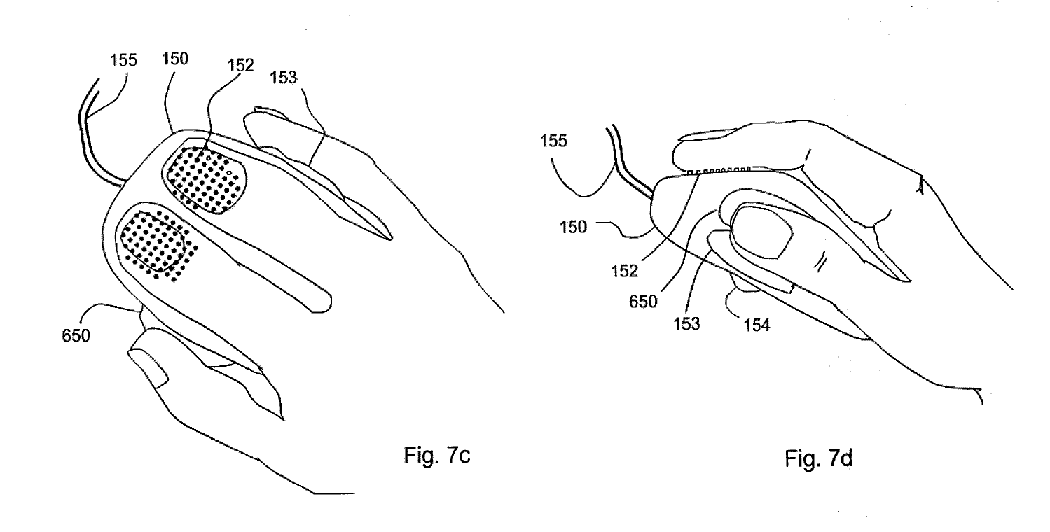

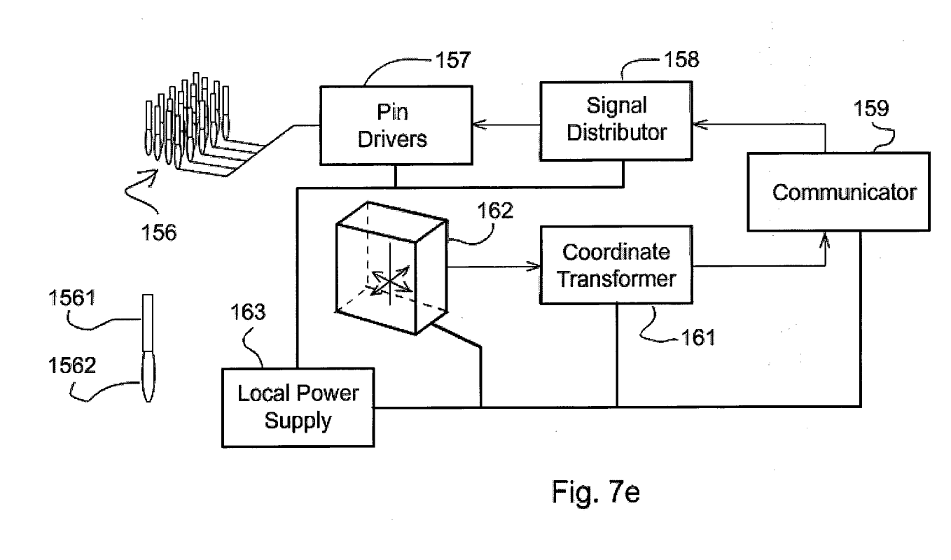

FIG. 2 is similar to FIG. 1, but also includes the addition of a handheld gesture input device (GID), referenced 31, which interacts with computer 10 via signal interpretation software 60, so as to enable the input of commands to computer 10; and, as part of display 20, there is included a non-visual display (NVD) 21 with appropriate software 80. In accordance with a preferred embodiment of the invention, NVD 21 includes at least one tactile output device 150 as exemplified herein in FIGS. 7a-e, and 9-13, and as described hereinbelow in detail. Preferably, there is also provided audio output apparatus. Software 60, NVO 21 with software 80 and GID 31 which, in accordance with one embodiment of the invention is a tactile mouse as shown and described below in conjunction with FIGS. 7a-7e, together form the gesture interface system of the present invention. As described below, tactile output will be received by a user either as command prompts/instructions, when a command has been successfully completed, or as real time feedback when performing a gesture.

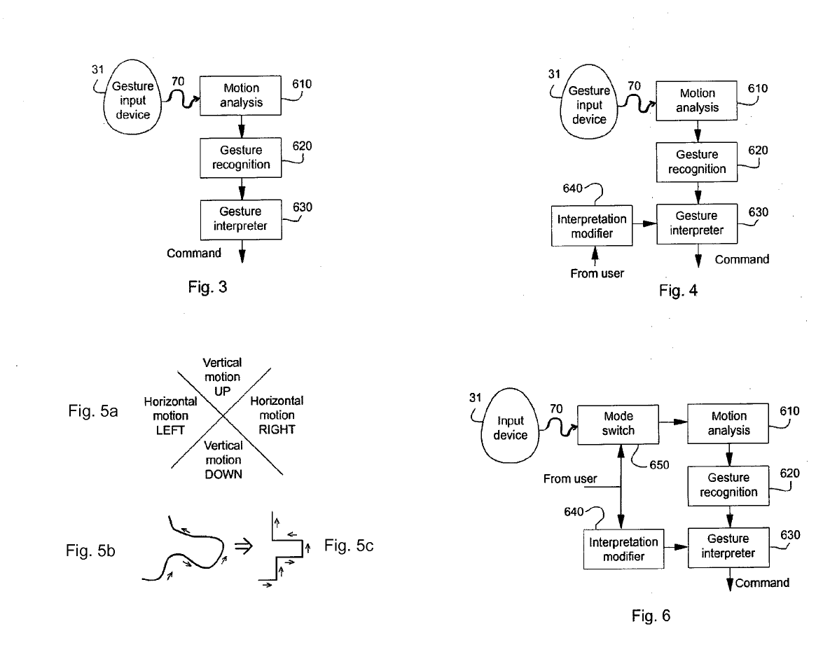

Referring now to FIGS. 3, 4 and 6, there is shown, in various modifications, the interface system of the invention, adapted for the inputting of commands into a computer by a predetermined combination of motions or gestures.

In the illustrated functional block diagrams, there is shown GID 31 of the invention, which is specifically adapted for facilitating the input of commands by gesture, as described herein. In a preferred embodiment of the invention, GID 31 is a tactile mouse as described herein, thereby to incorporate navigation, command and data input/selection, and tactile output, in a single, handheld device.

As seen, GID 31 communicates with the computer 10 (FIG. 2) via a communication channel 70 and signal interpretation software 60 (FIG. 2). Software 60 includes the functions of motion analysis, shown at block 610 (FIG. 3); gesture recognitions, shown at block 620; and gesture interpreter, shown at block 630, the output from which is a computer command GID 31 includes a hand-holdable housing, such as that of a computer mouse, and sensor apparatus for sensing predetermined sequences of motions of the housing with respect to a biaxial system and for transmitting signals to a computer corresponding to sensed combinations of motions of the housing. Typical sensor apparatus is exemplified by position sensors 154 in FIG. 7e, below.

As described, signal interpretation software 60 is operative to interpret the signals and to emit a predetermined command to the computer corresponding to the sensed gesture.

The simplest or basic system is illustrated in FIG. 3, in which each gesture, such as those described hereinbelow, corresponds to a unique command only.

In a preferred embodiment of the present invention, each gesture is constituted by piecewise linear approximation of several component motions. Each gesture may be constituted by a number of component motions, each of which must occur along one of the following two axes, as illustrated in FIG. 5a. There thus result four possible motion directions, namely, left, up, right, and down. Thus, by way of example, an “L” shaped gesture includes a series of two, mutually perpendicular, component motions. More precisely there can be considered two “L” shaped gestures: the first is down and right, the second is left and up. It will be appreciated that other axial arrangements may also be considered, and that the presently described bi-axial orthogonal system is by way of example, only.

Motions of the hand held mouse type gesture device 31 will typically not occur along a straight line in a particular direction, without deviation therefrom. Accordingly, there is provided an algorithm for the piecewise linear approximation of motions, and for interpretation thereof as being in one of the four directions in a given plane, as indicated in FIG. 5a. FIGS. 5b and 5c show the transformation of arbitrary mouse motion to a gesture consisting of straight horizontal and vertical component motions. More details about this algorithm are given hereinbelow in conjunction with gesture recognition algorithms.

Gestures that may be among those typically used in the present system are combinations or sequences of at least two sequential component motions, and include the following:

A. Left, right, up, down

B. Left+left; up+up; right+right; down+down

C. Left+right; right+left; up+down; down+up

D. Left+up; left+down; right+up; right+down

E. Up+left; up+right; down+left; down+right

Preferably, the present invention employs these twenty gestures, of which the first four (Group A) are single component motion gestures, while the remaining sixteen are composed of two component motions. While it is of course possible to recognize sequences having three or four component motions, they are more complex, and may thus be difficult to remember and to perform accurately, and so are less desirable than those one and two component motion gestures listed above. However, in order to use the same gestures for the generation of different commands, and thus increase the number of available commands, the keys of a computer keyboard and/or the buttons of a mouse such as illustrated in FIG. 7, may be used as modifiers, as described above in conjunction with FIG. 4.

The system in FIG. 4 is considered to be a multi-level system, such that each combination of motions may be interpreted as two or more commands. This is achieved by the provision of one or more gesture interpretation modifiers, referenced 640. In the present example, a single modifier only is shown, illustrated as a press button switch 153 on the tactile mouse 150 shown and described herein in FIGS. 7a-7d. Alternatively, one or more interpretation modifiers 640 may be provided by designation of keys on a conventional-type computer keyboard, for example. This allows multiplication of the twenty basic gestures exemplified above by the number of modifiers in use.

Shown in FIG. 6 is a system which is a further enhancement of the system presented in FIG. 2, wherein GID 31 is a tactile mouse as described herein, and includes a specific gesture mode activation switch 650 so as to prevent the system from interpreting accidental or non-specific movements of the mouse which were not actually intended to convey anything in particular. The switch 650 can be implemented as a button switch on the GID 31 itself, as shown in FIGS. 7a-7d, or as one of the keys on a conventional type keyboard.

In an alternative embodiment, mode selection can be effected by programming one or more of the keys of the computer keyboard.

It will be appreciated that while in existing systems for the blind there are used keyboard key combinations for issuing commands, e.g. Ctrl+Shift+}, NumLock+4, and the like, in those situations the blind user has to remove both hands from the specific output devices such as refreshable Braille display (RBD), find and press the required keys and then return his hands back to RBD. In the embodiment of the present system, in which the GID 31 is implemented in a tactile mouse (FIGS. 7a-7e), as the tactile mouse may be used both for input and output (by virtue of the tactile output devices thereof), the embodiment of GID 31 in a tactile mouse facilitates operation of the computer including gesture control as described herein, without requiring the user to remove his hands therefrom. This is especially valuable for people who have only limited use of their hands.

Practically, the system may be configured so as to facilitate the performance of any desired command or navigation action by predetermined gestures such as those are listed above, particularly when the system is used by a visually impaired user. The following are typical commands, for illustrative purposes only.
Switch between windows
Move the cursor to the screen center, its top-left corner, others
Move the cursor to the beginning of current/previous/next line/paragraph
Read text with a speech synthesizer.
Move the cursor to a search box, favorites bar, or the like.

Referring now to FIGS. 7a-7e, there is shown, in accordance with an embodiment of the invention, GID 31 (FIG. 2) in the form of a tactile mouse, referenced generally 150. By way of example, tactile mouse 150 may be manufactured in accordance with U.S. Pat. No. 5,912,660 entitled Mouse-Like Input/Output Device with Display Screen and Method for Its Use, the contents of which are incorporated herein by reference. It will be appreciated by persons skilled in the art, that tactile mouse 150, while being a single device, in fact embodies input means and output means which together form a bi-directional tactile input/output system, the functions of which could be provided by separate input and output devices.

Referring now to FIGS. 7a-7e, tactile mouse 150 is a bi-directional communication device providing a tactile output to a user via tactile displays 152, in addition to input controls via push buttons 153 used as a command entering mechanism, which may be pressed, released, clicked, double-clicked, or otherwise used to provide feedback to the computer; and a mechanism 154 (FIG. 7e) such as a roller-ball, optical sensor, or the like for sensing the position of the tactile mouse relative to its previous position.

It will be appreciated that while use of tactile mouse 150 is most convenient, embodying both data output and input in a single device, its functions may also be provided separately, for example, by provision of tactile displays 152, and input buttons/switches 153, respectively, on separate devices which cumulatively combine to provide the necessary functions input/output functions required in accordance with the present invention.

The position sensors 154 are provided to measure the variation of at least two spatial coordinates. The position of tactile mouse 150 is transmitted to the computer, typically via a connecting cable 155, such that each shift of the tactile mouse 150 on a work surface corresponds to a shift of the cursor of tactile mouse 150 on the visual display of the computer. These features allow the tactile mouse 150 to send input data to the computer in the same way as a conventional computer regular mouse.

As stated above, in addition to the input mechanism, a tactile mouse 150 has one or more tactile output displays 152 for outputting data from the computer to the user. Each tactile display is typically a flat surface (although the surface may be curved) having a plurality of pins 156 which may rise or otherwise be embossed in response to output signals from the computer. In certain embodiments, the tactile mouse 150 has a rectangular array of mechanical pins with piezoelectric actuators. The pins may be arranged with a density of say 1.5 mm distance between neighboring pins. Other pin configurations or other types of embossed display will occur to the skilled practitioner.

One embodiment of a driving mechanism for the tactile display 152 of the tactile mouse 150 is represented by the block diagram of FIG. 7e. The main elements of the driving mechanism are an array of pins 156, a pin driver 157, a signal distributor 158, a communicator 159, a coordinate transformer 161, a position sensing mechanism 162 and a local power supply 163 powering all electronic mechanisms of the tactile mouse, including the tactile display 152.

As the tactile mouse 150 moves over a surface, the sensing mechanism 154 is operative to track the movements thereof. The movements of the mouse 150 are transformed into a set of coordinates by the coordinate transformer 161 which relays the current coordinates of the mouse to a computer via a communicator 159. The communicator 159 is further operative to receive an input signal from the computer relating to the display data extracted from the region around the tactile mouse cursor. The input signal from the computer is relayed to the signal distributor 158 which sends driving signals to the pin drivers 157. Each pin driver 157 typically drives a single pin 156 by applying an excitation signal to an actuator 1562 such as a piezoelectric crystal, plate or the like configured to raise and lower a pin 1561.

The tactile mouse 150 may be connected to the computer via standard communication channels such as serial/parallel/USB connectors, Bluetooth, wireless communication or the like. The operational interface between the tactile mouse 150 and the computer system has an input channel for carrying data from the tactile mouse 150 to the computer and an output channel for carrying data from the computer to the tactile mouse 150.

Regarding the input channel, when the position sensor 154 of the tactile mouse 150 is moved along a flat working surface, the sensors measure relative displacement along at least two coordinate axes. These coordinates are converted by embedded software, into signals which are organized according to an exchange protocol and sent to the computer. Upon receiving these signals, the operating system decodes and transforms them to coordinates of the tactile mouse cursor on the computer screen. Thus, the motion of the tactile mouse cursor over the screen corresponds to the motion of the tactile mouse 150 over its working surface. The exchange protocol also includes coded signals from the tactile mouse 150 indicating actions associated with each of the input buttons such as a press signal, a release signal, a double click signal and the like.

Regarding the output channel, the output signal sent from the computer to the tactile mouse 150 depends inter alia upon the coordinates of the tactile mouse cursor, and the visual contents displayed at within a predetermined range of those coordinates upon the screen.

Accordingly, the tactile display of the tactile mouse 150 may output a text symbol, graphical element, picture, animation, or the like. Like the regular system cursor, the tactile mouse cursor determines its own hotspot.

Tactile mouse 150 is of particular utility for visually impaired users as it makes the information stored in a computer far more accessible to them. There are a number of reasons for this increased accessibility, notably:
The tactile mouse 150 can be effectively used for navigation among a large amount of information presented on display 20.
The movable nature of the tactile mouse 150 allows large amounts of contextual, graphical, and textual information to be displayed to the user by tactile mouse displays 152.
Braille and other symbols are displayed to the user in embossed form, providing an additional tactile channel for the presentation of text.
Graphic objects may also be represented displayed in embossed form; e.g., a black pixel may be displayed as a raised pin and a white pixel as a lowered pin. Similarly, a gray pixel may be displayed as a pin raised in an intermediate height or transformed to black or white depending on a certain threshold. Similar operations can be performed with pixels of all other colors.
The use of a tactile mouse 150 in a similar manner to the mouse of a sighted user may be a strong psychological motivator for a visually impaired user to access the computer information.

### Gesture Recognition Algorithms

As described above, it is necessary to be able to distinguish between gestures and the other GID motions. Such distinction may be implemented in software in different ways, and the following are non-limiting illustrative examples of such implementation.

### Component Motion Recognition

It should be taken into account that mouse-like devices give relative and not absolute location and shift measurements.

### A. Continuous Motion

As per FIG. 5 we have to differentiate between motion directions which, in the present embodiment, vary by 90° from each other:

i. x>|y| for right

ii. −x>|y| for left

iii. |x|<y for up

iv. |x|<−y for down.

Here (x, y)—GID's coordinates in an orthogonal coordinate system and |z|—absolute value of a variable z.

### Algorithm for the Implementation of Continuous Motion:

Suppose (x₀, y₀) is a starting point of the device. If during N₁ and further measurements, one of the four conditions above (for example ii) is kept for current device coordinates (x, y), thus ii is the direction. Here, N₁ is an adjustable parameter. The smaller N₁ is, the greater is the user accuracy that is required. Larger values of N₁ are convenient for people with motor skills disorder. Many other algorithms (here and below) can be used.

### B. Start Motion

This task requires differentiation between the start of a real gesture, and an accidental shift. If the number of shifts in one direction, any of i-iv above, exceed a predetermined adjustable threshold N₂, then the motion is recognized as the beginning of a gesture. Again, larger values of this parameter are recommended for users with motor disorders, but such large values may be inconvenient for use by experienced users.

### C. Stop Motion

This task requires differentiation between the termination of a real gesture, and a brief interruption in the motion, and is based on the detection of generally continuous motion. Such interruptions may be due to the user, because of errors in the mouse's motion sensor or a poor quality mouse travel surface. Accordingly, if during a specified time period N₃, no motion signals are detected from the sensor in GID 31, then the gesture has stopped.

### D. Consecutive One Directional Multiple Component Gestures

The one-directional gestures, as example, are referred to mentioned above: left+left; up+up; right+right; down+down.

Each of them is a series of two (and possibly more) primitive motions separated with temporary ‘decelerations,’ which, in the context of the present invention, may be complete stops or merely slow downs. If such decelerations are allowed as separators between gestures (i.e. between two or more two-motion sequences), the speed of motion during deceleration has to be measured, thereby to determine whether the deceleration is a temporary deceleration within one gesture or a separator between two gestures.

An algorithm for use in the interpretation of consecutive one directional multiple component gestures may be based on the assumption that the motion characteristics of the GID are generally uniform during a single component motion, and that a change in such characteristics cause a change in speed. Speed measurement is made continuously during movement of the GID, and a decrease in the speed by more than a predetermined adjustable parameter is considered to indicate the end of one component motion and the beginning of the next one.

### E. Consecutive Opposite Directional Gestures

Listed above as Group C is an exemplary group of opposite directional gestures, namely, left+right; right+left; up+down; down+up.

Each of these gestures is a sequence of two or more motions with stops and/or a change of motion direction such that the direction of the second motion is opposite to the first.

### F. Consecutive Mutually Perpendicular Gestures

These gestures are those mentioned above, namely, left+up; left+down; right+up; right+down and up+left; up+right; down+left; down+right.

Each of these gestures is a sequence of two or more motions with stops and/or a change of motion direction such that the direction of the second motion is perpendicular to the first.

### Algorithm for the Implementation of Mutually Perpendicular Gestures

A direction of each new vector (xₙ₊₁−xₙ, yₙ₊₁−yₙ) is compared with the known direction of the previous vector (xₙ−x₀, yₙ−y₀). If the direction of the new vector differs from the previous direction by a value approximating to 90°, a change in direction is determined to have occurred. If the new vector reaches a predetermined length when measured in terms of the number of same directional steps, this vector is determined to be a new component motion in a mutually perpendicular direction to the previous component motion.

### Training Users of the Gesture-Based System

As described hereinabove, the system of the invention is ideally suited for the visually impaired, as it relies on tactile perception for output and on manual movements for input performed while holding the GID 31 of the present invention, and is preferably incorporated into a tactile mouse as shown and described hereinabove in conjunction with FIG. 7.

It is recognized, however, that the capability of entering commands into a computer by simple gestures as shown and described above, is one that because it is novel, will by definition, be initially unfamiliar to a user. Accordingly, in order to assist a new user, and particularly, although not exclusively, a visually impaired new user, in becoming familiarized with the inputting of commands as described hereinabove, by use of gestures, there are provided various training exercises so as to assist. It will be appreciated that in order to be most effective and so as to have the broadest appeal, especially to those who may not consider themselves to be computer literate, the exercises are preferably provided in the form of interactive games, thus being enjoyable, and having appeal to users of all ages.

In a further embodiment of the invention, the herein-described interactive games can employing the GID 31 of the present invention may also considered to be stand alone, and may be enjoyed by users without a particular learning achievement in mind.

As described above, each gesture is a sequence of motions, and apart from being interpreted as entering specific computer control or input commands, they can also be used as a manner of playing a game in which virtual spatial motions are required.

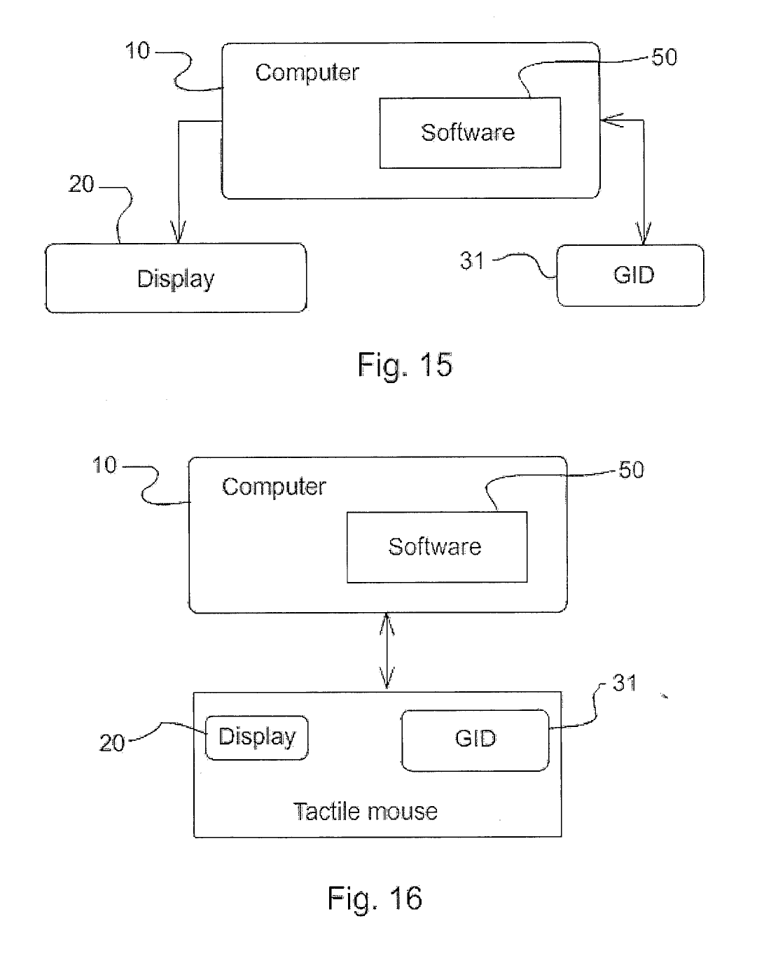

For the purpose of clarity, the training exercise or games described will be described with reference to FIGS. 15 and 16.

FIG. 15 is a schematic block diagram of a computer system, similar to that shown and described hereinabove in conjunction with FIG. 2, and which includes a computer 10 having software 50, display 20, and a gesture input device 31. The display 20 may include as non-visual display means 21 (FIG. 2) one or more tactile pads 152 (FIGS. 7a-7d), integrated into a tactile mouse 150 as shown and described hereinabove in conjunction with FIGS. 7a-7d, as well as a visual display screen. It is also envisaged that both may be provided so that two or more users can either play the hereinbelow described games simultaneously, or so that one may train the other in correct use of the computer system or portions thereof.

FIG. 16 shows a similar system to that of FIG. 15, but whereas in the system of FIG. 15 the GID 31 and display 20 are separate units, in the embodiment of FIG. 16, they are both incorporated into a tactile mouse 150, as shown and described hereinabove on conjunction with FIGS. 7a-7d.

The software 50 will preferably be programmed to perform the following:

(i) by use of a tactile display, to display to a user instructions for the performance of at least one predetermined gesture; these instructions may also be provided as an audio output;
(ii) to detect the performance of a gesture by the user;
(iii) to compare the gesture performed by the user with the required gesture; and
(iv) to provide feedback, preferably by means of a tactile output device but optionally also or instead, by audible means, so as to indicate to the user whether or not the gesture performed was equal to that required.

The various exercises and games described below are preferably based on the system arrangements of FIG. 15 or 16, or on variations thereof, and are merely for exemplary purposes.

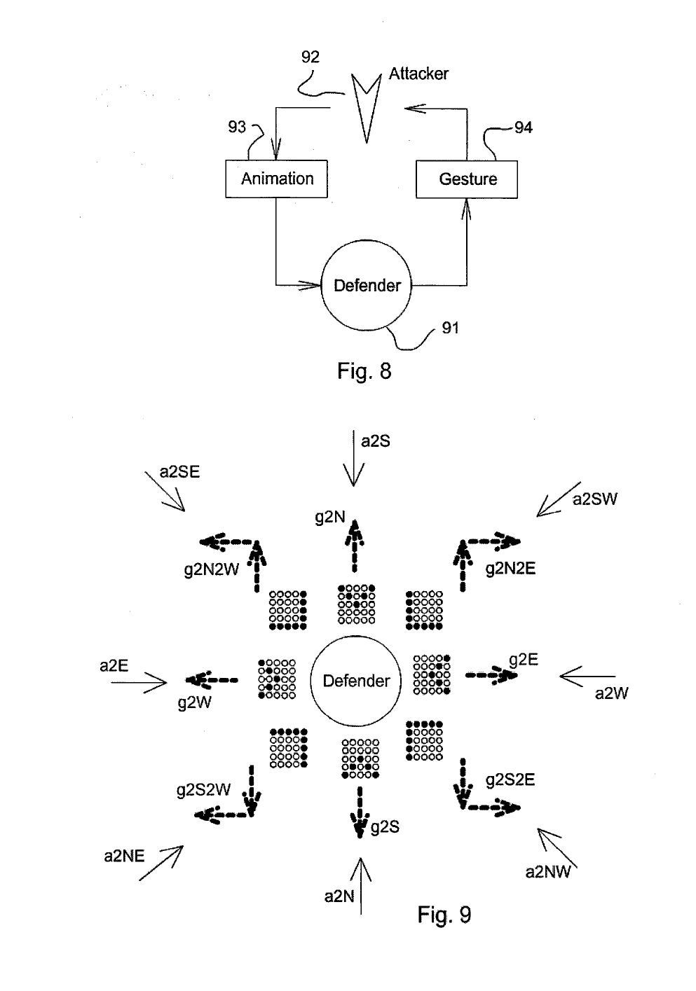

Accordingly, referring now to FIG. 8, there is illustrated a game, which may also be played by sighted users, in which a user or player is a ‘defender’ 91 who has to defend himself from an ‘attacker’ 92. Animation software 93 is employed by the system so as to activate the tactile displays 152 (FIGS. 7a-7d), for example, in a manner such as shown and described in conjunction with FIGS. 10-13, in order to provide the user with information regarding the direction of an attack.

Accordingly, referring now to FIGS. 8 and 9, when an attack starts (attacker 92 appears from a predetermined direction and approaches the defender), a corresponding animation starts to run on one or more tactile output devices (FIGS. 10-13), so as to be easily perceptible by the player or defender 91. The player has to recognize an attack direction and react with an appropriate gesture, such as described herein. Only one gesture will have the effect of beating back the attack. If the selected gesture is correct, then the attack is deflected, and the player is credited with points. If the selected gesture is incorrect, then the attacker will succeed in reaching the defender so as to destroy or wound it and points are subtracted. Thereafter a new attack starts either from the same or a different direction depending on the game rules. Attack directions can be selected randomly. More than one tactile output device can be used for showing animations. Preferably, sound effects are also provided.

In accordance with various embodiments of the invention, the rules may be modified such that each successive attack is faster, or the speed of the attacks may slow down or speed up in accordance with the skill of the player in beating off the attacks.

As seen in FIG. 9, the defender has a 360° exposure to attack. Any number of attack directions can be implemented in the game. As shown by way of example in FIG. 9, eight attack directions are shown by the full, inward-pointing arrows. When viewed clockwise, the arrows are respectively referenced a2S (attack to South), a2SW (attack to South-West), a2W and so on, all the way around until a2SE. Simplified versions of the game will include a decreased number of attack directions, such as:

all attacks from one direction only;

only frontal attacks: a2S, a2SW and a2SE;

four directional attacks.

The defense directions, representing the gestures that need to be made by the defender with GID 31 in order to counter or beat off an attack have to correspond to number and directions of possible attacks. For version with eight possible directions of attack, a corresponding number of eight defense directions are shown by the broken-line arrows, respectively referenced g2N (gesture to North), g2N2E (gesture to North and then to East) and so on, all the way around until g2N2W. This does not limit a use of gestures in all possible diagonal directions, for example, GID motion to North-West, North-East, and so on.

As seen, therefore, one of eight pairs of a solid line and animation shows the attack direction. For example, arrow a2SW signifies an attack from the north-east to the south-west. To deflect such attack a gesture g2N2E, requiring the GID 31 to be moved up and then right, is required. In this example, any other gesture will cause a loss for the defender, and a loss in points.

As stated above, while the animations showing attack and defense may be shown in visual form on a computer screen, they are preferably shown, either in addition or exclusively, on tactile output devices of the tactile mouse exemplified herein, for the training and enjoyment of visually impaired users. Each of the displays, referenced 100 in FIGS. 10-13, has an array of vertically displaceable pins 156, wherein pins in a raised position are indicated in the drawings by solid black circles, while the pins having a circular outline only are non-raised.

Accordingly, referring now to FIG. 10, the succession of representations a-h shows how an arrow, indicated by a simple V-shape, propagates from the left or the west, and moves towards the right or to the east; the tip of the arrow is seen in representation a, the trailing ends are seen in representation g, and the tip of the next incoming arrow is seen in representation h.

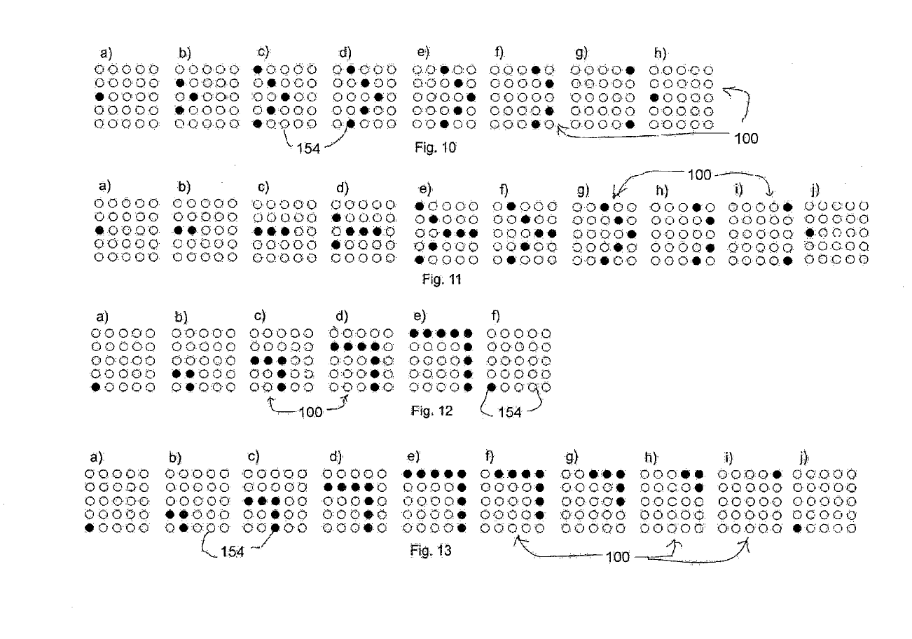

FIG. 11 shows an animated arrow which has been modified for easy recognition.

FIG. 12 shows an arrow going from south east to north east.

FIG. 13 also shows an arrow going from south east to north east, but whereas the arrow in FIG. 12 seems to disappear suddenly (after representation e), the same arrow is shown in FIG. 13 to trail off gradually, as seen in representations f-j.

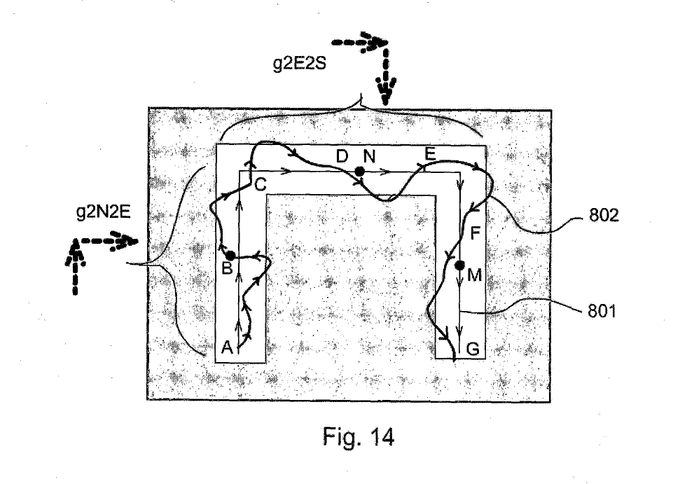

Referring now to FIG. 14, there is shown an alternative type of game, which may also serve as a gesture training exercise, namely, traversing a labyrinth. It will be appreciated that the labyrinth may be formed to be as simple or as complicated as desired, and that FIG. 14 shows only a simplified portion, for illustrative purposes only. This embodiment of the invention will be described solely in conjunction with the tactile output devices of a tactile mouse as described above, serving also as GID 31.

In the illustrated game, a traveler, namely the user, needs to traverse and exit a labyrinth. The labyrinth is shown as a white road on a black background. On the tactile output device, white is represented by the pins in a down position, while black is represented by raised pins.

Preferably, if two tactile displays are being used, one of them can show the colors (black/white) of the location of the traveler relative to the labyrinth, while another, activated as for example by animation software 93 (FIG. 8), can display possible directions for movement within the labyrinth. Clearly, if more than two tactile output devices are employed, there exist further options for the provisional of additional information to the user.

Simple movement of the tactile mouse results in a corresponding movement of the player within the labyrinth, and can enable the player to reach the goal, namely, to find his/her way out of the labyrinth. However, if the player uses correct gestures in response to animations provided at certain specific locations, by use of gestures or specific gross motions, travel can be accelerated significantly by jumping from one location to another.

In the example of FIG. 14, the player starts at location A and must reach location G. One way to do this is to move as shown by line 801. This line may be optionally displayed as a guide, on the tactile output device by raised pins.

If the player moves the GID 31 based only on tactile perception, a possible trajectory may be as shown by the curved line A-B-C-D-E-F-G. The time that this takes may be prolonged, especially if the game rules decelerate motion when the GID's cursor is out of the main road (black color).

The role of gestures in the game is to help the user anticipate and take advantage with regard to shortening in the route. For example, during motion along the vertical path from point A, the gesture g2N2E (move North and then East) may be displayed to the user, signifying to the user that a bend in the route is ahead. The user may, at that time, choose to ignore the gesture, and continue gradually moving along the road, possibly following a path as shown by the curved line A-B-C-D-E-F-G. If however, he performs the indicated gesture, this will have the effect of enabling him to jump from the point where the cursor is currently located, for example B, to a point around the corner, for example N. Similarly, a gesture g2E2S may be displayed at point N, the performance of which by the user will cause him to jump around the corner, to point M.

The more quickly the player becomes used to the concept of ‘reading’ gestures and performing them correctly, the more time will be saved, leading to an ability to traverse the labyrinth more quickly. It will be appreciated that this will assist in the user becoming used to the types of motions required so as to learn how to operate a computer by using the GID 31.

Additional variations to the above labyrinth game are contemplated, including but not limited to different levels of difficulty and the addition of additional, possibly more complex gestures, thereby to increase the skill of a user.

It will be appreciated that the scope of the present invention is not limited to that shown and described hereinabove. Rather the scope of the present invention is defined solely by the claims, which follow:

1. A system for the inputting of gesture generated commands into a computer by a user, which includes:
(a) a hand movable input device which includes:
(i) a hand-holdable housing for the effecting of a gesture by a user; and
(ii) sensor apparatus for sensing predetermined motions of said housing with respect to a biaxial system and for transmitting signals corresponding to sensed motions of said housing, to a computer;
(e) signal interpretation software for interpreting signals from said sensor apparatus as being gesture-generated and for emitting a predetermined command to the computer corresponding to the gesture;
(f) non-visual display apparatus including at least one tactile output device; and
(g) a computer program for operating said non-visual display apparatus so as to provide to a user information relating to a combination of hand motions corresponding to a command.

2. A system according to claim 1, wherein said at least one tactile output device is mounted onto said hand-holdable housing.

3. A system according to claim 1, wherein said computer program operates said non-visual display apparatus so as to provide non-visual output containing information which includes the following:
(a) instructions for the movement of said input device in a sequence of hand motions required to input a selected command; and
(b) an indication as to the successful completion of the sequence of hand motions required to input a selected command.

4. A system according to claim 3, wherein said computer program operates said non-visual display apparatus so as to also to provide feedback to the user in real time and in non-visual form as to the successful performance of a sequence of hand motions required to input a selected command.

5. A according to claim 4, wherein said computer program operates said at least one tactile output device so as to provide tactile output containing information which includes at least one of the following:
(a) instructions for the movement of said input device in a combination of hand motions required to input a selected command;
(b) an indication as to the successful completion of a combination of hand motions required to input a selected command; and
(c) feedback as to the successful performance of a combination of hand motions required to input a selected command.

6. A system according to claim 1, wherein said apparatus for sensing is operative to sense predetermined sequences of motions of said housing wherein each said sequence includes at least two motions performed consecutively.

7. A system according to claim 6, wherein said axes are orthogonal linear axes defined by said sensor apparatus and each said motion is performed with respect to a single axis of said pair of axes.

8. A system according to claim 7, wherein said signal interpretation software is operative to approximate each motion as being along a straight line.

9. A system according to claim 1, wherein said hand movable input device is a tactile computer mouse.

10. A method of gesture operation of a computer so as to effect a selected task, including the following steps:
(e) manually moving a hand held computer interface device in order to perform a gesture required to effect a task;
(f) detecting the motion of the interface device with respect to a biaxial system;
(g) comparing the motions performed with those required to effect the selected task; and
(h) providing non-visual feedback to the user as to whether or not the gesture was performed successfully.

11. A method according to claim 10, also including at least one step of displaying to a user in non-visual form one or more instructions for one or more motions required for the performance of a gesture in order to effect the selected task.

12. A method according to claim 10, also including, during the performance of step (a) of manually moving, the step of providing non-visual feedback to the user as to whether or not component motions of the gesture were performed successfully.

13. A method according to claim 10, wherein step (d) displaying includes providing tactile feedback to the user.

14. A method according to claim 11, wherein in said at least one step of displaying, said instructions are provided in tactile form.

15. A method according to claim 10, wherein in said step (b) detecting, said axes are orthogonal linear axes; each motion is performed with respect to a selected one of said axes; and said step (b) includes the step of approximating each motion as being along a straight line.

16. A method according to claim 10, comprising a tactile computer game.
